(19) United States
(12) Patent Application Publication
(10) Pub. No.: US 2009/0208400 A1
(43) Pub. Date: Aug. 20, 2009

(54) METHOD AND CRUCIBLE FOR DIRECT SOLIDIFICATION OF SEMICONDUCTOR GRADE MULTI-CRYSTALLINE SILICON INGOTS

(76) Inventors: Stein Julsrud, Skien (NO); Tyke Laurence Naas, Porsgrunn (NO)

Correspondence Address: BIRCH STEWART KOLASCH & BIRCH, PO BOX 747, FALLS CHURCH, VA, 22040-0747, US

(21) Appl. No.: 12/306,516

(22) PCT Filed: Jun. 22, 2007
(86) PCT No.: PCT/NO2007/000226

§ 371 Date: Apr. 15, 2009

Related U.S. Application Data
(60) Provisional application No. 60/815,858, filed on Jun. 23, 2006.

(51) Int. Cl. C01B 33/02; B01D 9/00; B28B 1/14

(52) U.S. Cl. 423/348; 422/245.1; 264/299

(57) ABSTRACT

This invention relates to a method for direct solidification of semiconductor grade multi-crystalline silicon ingots allowing improved control with the solidification process and reduced levels of oxygen and carbon impurities in the ingot, by crystallizing the semiconductor grade silicon ingot, optionally also including the melting of the feed silicon material, in a crucible made of silicon nitride, or in a crucible made of a composite of silicon carbide and silicon nitride, and where the wall thickness of the bottom of the crucible is dimensioned such that the thermal resistance across the bottom is reduced to a level of at least the same order as thermal resistance across the support below carrying the crucible or lower. The invention also relates to crucibles which are made of silicon nitride, or of a composite of silicon carbide and silicon nitride, and where the wall thickness of the bottom of the crucible is dimensioned such that the thermal resistance across the bottom is reduced to a level of at least the same order as thermal resistance across the support below carrying the crucible or lower.

This invention relates to a method for direct solidification of semiconductor grade multi-crystalline silicon ingots allowing improved control with the solidification process and reduced levels of oxygen and carbon impurities in the ingot. The invention also relates to crucibles enabling the method.

### BACKGROUND

The world supplies of fossil oil are expected to be gradually exhausted in the following decades. This means that our main energy source for the last century will have to be replaced within a few decades, both to cover the present energy consumption and the coming increase in the global energy demand.

In addition, many concerns are raised that the use of fossil energy increases the earth greenhouse effect to an extent that may turn dangerous. Thus the present consumption of fossil fuels should preferably be replaced by energy sources/carriers that are renewable and sustainable for our climate and environment.

One such energy source is solar light, which irradiates the earth with vastly more energy than the present day consumption, including any foreseeable increase in human energy consumption. However, solar cell electricity has up to date been too expensive to be competitive. This needs to change if the huge potential of the solar cell electricity is to be realised.

The cost of electricity from a solar panel is a function of the energy conversion efficiency and the production costs of the solar panel. Both the production cost of solar cells and the energy efficiency should be improved.

The dominating process route for silicon based solar panels of multi-crystalline wafers are presently by sawing multi-crystalline ingots into blocks and then further to wafers. The multicrystalline ingots are formed by directional solidification by use of the Bridgman method or related techniques. A main challenge in the ingot fabrication is to maintain the purity of the silicon raw material and to obtain a sufficient control of the temperature gradients during the directional solidification of the ingots in order to obtain satisfactory crystal quality.

The problem with contamination is strongly connected to the crucible material since the crucible is in direct contact (or indirect contact through a release coating) with the molten silicon. The material of the crucibles should therefore be chemically inert towards molten silicon and withstand the high temperatures up to about 1500° C. for relatively long periods. The crucible material is also important for achieving an optimal control of the temperature since the heat extraction during solidification of the ingot in these production methods is obtained by maintaining a lower temperature in the area below the crucible support, creating a heat sink for the heat of crystallization and transported heat from the upper part of the furnace through the silicon melt, silicon crystals, crucible bottom and support plate. The upper part of the furnace consists of the volume above the support plate, including the crucible or crucibles with contents.

Heat is transported from a higher to a lower temperature according to Fourier's law of heat conduction, which in one-dimensional form can be written as:

$$\frac{\dot{Q}}{A} = - \frac{1}{\sum \frac{Δ {x}_{i}}{{k}_{i}}} \cdot Δ T$$

wherein \dot{Q}/A is the heat transported per area, Δxᵢ is the thickness of material layer i, kᵢ is the thermal conductivity of material i and ΔT is the total temperature difference. With multiple layers, the temperature difference across each layer is proportional to the thermal resistance, Δxᵢ/kᵢ.

In present day industrial production based on the Bridgman method, the crucibles usually stand on a graphite platform of dimensions sufficient to carry the load of the filled crucibles. The necessary thickness for mechanical stability will be in the range 3-10 cm. The thermal conductivity of isotropic graphite is in the range 50-100 W/mK.

### PRIOR ART

Silicon dioxide (fused silica), SiO₂, is presently the preferred material for crucible and mould applications due to availability in high purity form. The thermal conductivity of the fused silica material from which the crucible is made is around 1-2 W/mK. The crucible walls and bottom will typically have a thickness in the range of 1-3 cm. Thus, in the configuration presently employed by the industry, the crucible bottom is the dominating thermal resistance. With typical crucible bottom thickness of about 2 cm and support plate thickness 5 cm, 90-98% of the total temperature difference is localised across the crucible bottom.

The attainable rate of heat removal is limited by the great thermal resistance of the silica crucible. Also, any attempt to vary the heat flux locally, e.g. in the lateral direction will be hampered by the very low possibility to control the heat flux.

The heat flux from the heat of crystallization of the silicon, the heat transported from the top heater to the bottom heater through the ingot and crucible and the heat stored in the materials in the hot zone should ideally be vertically oriented, i.e., have no lateral component. However, in current practice, the various known furnace designs are all characterized by lateral transport of heat. This gives rise to thermal stresses and generates dislocations in the crystallized silicon.

The use of silicon oxide crucibles also entails a problem of contamination of the silicon ingot, since the reaction products of Si and SiO₂ is gaseous SiO, which may subsequently escape the molten metal and react with graphite in the hot zone forming CO gas. The CO gas readily enters the silicon melt and thus introduces carbon and oxygen into the silicon. That is, the use of a crucible of oxide-containing materials may cause a sequence of reactions leading to introduction of both carbon and oxygen in the solid silicon. Typical values associated with the Bridgman method is interstitial oxygen levels of 2-6·10¹⁷/cm² and 2-6·10¹⁷/cm² of substitutional carbon.

Build-up of carbon in the silicon metal may lead to formation of needle shaped SiC crystals, especially in the uppermost region of the ingot. These needle shaped SiC crystals are known to short-cut pn-junctions of the semiconductor cell, leading to drastically reduced cell efficiencies. Build up of interstitial oxygen may lead to oxygen precipitates and/or recombination active oxygen complexes after annealing of the formed silicon metal.

### OBJECTIVE OF THE INVENTION

The main objective of the invention is to provide a method for direct solidification of ingots which obtains an improved control with the temperature profile and the contamination levels of oxygen and carbon for production of high-purity ingots of semiconductor grade silicon.

Another objective of the invention is to provide crucibles enabling the method according to the main objective.

The objective of the invention may be realised by the features as set forth in the description of the invention below, and/or in the appended patent claims.

### DESCRIPTION OF THE INVENTION

The invention is based on the realisation that the control of the solidification process will be significantly improved by reducing the thermal resistance across the bottom of the crucible to a level at the same order or lower than the thermal resistance across the support below the crucible, and on the realisation that the problem with contamination of the silicon ingots with carbon and oxygen is largely connected to use of oxygen-containing materials in the crucible.

For present day direct solidification furnaces, including those based on the Bridgman method, the thermal resistance across the graphite support carrying the crucible is typically in the order from 0.002 to 0.0003 m²K/W (thickness typically from about 3 to about 10 cm and thermal conductivity in the order of 50 to 100 W/mK). For a crucible with bottom thickness of 1-3 cm, this implies that the thermal conductivity of the crucible material should be at least about 5 W/mK or higher. Also, the crucible must be made of a material that does not contaminate the silicon to an unacceptable degree, and which has a similar or lower thermal expansion than solid silicon. Suitable materials are silicon nitride, Si₃N₄, silicon carbide, SiC, or a composite of the two. Examples of thermal conductivities and coefficients of thermal expansion for these materials may be found on the website of the US National Institute of Standards and Technology; http://www.ceramics.nist.gov/srd/scd/sedquery.htm

Thus in a first aspect of the invention there is provided a method for production of semiconductor grade silicon ingots by directional solidification, where the presence of oxygen in the hot zone of the crystallisation furnace is substantially reduced or eliminated and the problem with insufficient control of the thermal gradient during solidification is solved by
crystallizing the semiconductor grade silicon ingot, optionally also including the melting of the feed silicon material, in a crucible made of silicon nitride, Si₃N₄, silicon carbide, SiC, or a composite of the two, and where
the wall thickness of the bottom of the crucible is dimensioned such that the thermal resistance across the bottom is reduced to a level of at least the same order as thermal resistance across the support below carrying the crucible or lower.

An increased rate of crystallization implies a larger thermal gradient across the crystallized silicon. This may cause increased stress in the crystalline silicon. However, thermal stress in the crystalline silicon may be minimised or even eliminated by ensuring that the heat flux is vertically oriented and linear. The situation where heat is extracted in such a way that the temperature gradients are linear within one material layer with respect to vertical position can be termed a quasi steady state cooling (or heating). It is possible to maintain this situation over a much wider range of cooling (heating) rates using the present invention.

An essentially vertically oriented beat flux is ensured by thermally insulating the sidewalls of the crucible, e.g, by using graphite or carbon felt to avoid transport of heat through the lower part of the crucible sidewall into the already crystallised and therefore cooler silicon ingot.

A process wherein heat flux through the crystallized silicon is always essentially vertical and the temperature gradients are essentially linear minimizes thermal stresses on the crystallized material, and consequently the number of stress-related crystal defects.

The method according to the first aspect of the invention may be employed for any known process for producing semiconductor grade multicrystalline silicon ingots, including solar grade silicon ingots by directional solidification such as the Bridgman process, the block-casting process, etc.

In a second aspect of the invention there is provided a crucible for manufacturing ingots of semiconductor grade multi-crystalline silicon by direct solidification, comprising a hot zone with an inert atmosphere, where
the crucible is made of silicon nitride, Si₃N₄, silicon carbide, SiC, or a composite of the two, and where
the wall thickness of the bottom of the crucible is dimensioned such that the thermal resistance across the bottom is reduced to a level of at least the same order as thermal resistance across the support below carrying the crucible or lower.

The use of silicon nitride or a silicon carbide and silicon nitride composite as the crucible material practically eliminates contact between liquid or hot silicon metal and the element oxygen (provided the atmosphere above the crucible is practically free of oxygen). This feature will cut off the chain of reactions described above leading to the introduction of oxygen and carbon contaminations in the silicon ingots, and thus substantially improve the present levels of oxygen and carbon contamination of multi-crystalline silicon.

A thermal resistance of at least the same size as the thermal resistance of the underlying support structure or lower, will move the thermal gradient from being across the crucible bottom to more generally across the formed crystals, crucible bottom and support. This makes it possible to control the crystallization process within a much wider range of crystallization rates, and the improved control of the amount of heat extracted opens for the following possibilities:
Creating a crystal nucleation part of the solidification cycle wherein the temperature is slowly ramped below the melting point of silicon at the inside of the crucible bottom allowing, larger, less strained crystals to nucleate.
Obtaining a controlled start of crystallization where the crucible is standing on a carbon material made up from isotropic and oriented graphite made into a pattern. The systematically varying heat flux in the plane makes it possible to further improve the start of crystallization and the initial number of crystals per area.
Creating cyclic or occasional re-melting which will remove the most strained crystals and further improve crystal quality.

### LIST OF FIGURES

FIG. 1, part a) to c) is a schematic view of plate elements that may be assembled to form a crucible for DS-solidification of silicon according to one embodiment of the invention. FIG. 1 d) illustrates the assembled crucible.

FIG. 2 part a) and b) is a schematic view of plate elements that may be assembled to form a crucible for DS-solidification of silicon according to a second embodiment of the invention. FIG. 2 c) illustrates the assembled crucible.

FIG. 3 shows a calculated temperature profile across the crucible bottom and underlying support in the case of using a prior art silica crucible.

FIG. 4 shows a calculated temperature profile across the crucible bottom and underlying support in the case of using a crucible according to the invention.

FIG. 5 shows a FEM calculation of crystallising silicon in an ingot with a patterned carbon plate underneath the crucible for a conventional silica crucible and a crucible according to the invention.

### DETAILED DESCRIPTION OF THE INVENTION

The invention will be described in further detail by way of examples of embodiments of the invention. These examples should by no means be considered to represent a limitation of the general inventive concept of employing crucibles of materials void of oxygen and with a thermal resistance across the bottom of at least the same order as thermal resistance across the support below carrying the crucible or smaller. Any material capable of being formed to a crucible with sufficient mechanical strength to carry the silicon metal, which meets the above stated requirements, and which can withstand the high temperatures and reducing environment of the hot zone in directional solidification furnaces may be employed.

The embodiments of example 1 and 2 are both crucibles with a square cross-sectional area made of nitride bonded silicon nitride, by
mixing silicon nitride powder with silicon powder, for example in an aqueous slip,
forming a set of green bodies in the form of plates that are to be the bottom and walls of a square cross-section crucible,
mounting the plate elements to form a crucible with square cross-sectional area and sealing the joints by applying a paste comprising silicon powder and optionally silicon nitride particles, and
heating the green bodies in a nitrogen atmosphere, thus converting the green bodies and the sealing paste to a nitride bonded silicon nitride (NBSN) plate elements by nitriding the silicon particles in the green body and the sealing paste according to reaction (I).

3 Si(s)+2 N₂(g)=Si₃N₄(s) (I)

The green bodies of the wall and bottom elements of the crucibles may be formed by making an aqueous slurry comprising >60 weight % silicon nitride particles and <40 weight % Si particles. Applying the aqueous slurry into a mould, preferably made from plaster with the net shape of plate element that is to be formed, including grooves and apertures in order to obtain plates suitable for assembly into crucibles. And then heating the green bodies in an atmosphere of essentially pure nitrogen up to a temperature above 1400° C. during which the silicon particles in the green bodies will react and form silicon nitride which bonds the silicon nitride grains and evaporate additives. The heat treatment in a nitrogen atmosphere is continued until all Si-particles in the slurry have been nitrided such that solid plates of silicon nitride are obtained. If necessary, the nitrided plates may be polished and shape-trimmed after cooling for obtaining accurate dimensions, and thus allowing forming tight and leaching proof crucibles upon assembly. When assembling the crucibles, a sealing paste made from silicon dispersed in a liquid may advantageously be deposited on the areas of the plate elements that will be in contact with adjacent plate elements when assembled. Then the plate elements are assembled, and the formed crucible is subject to a second heat treatment in an atmosphere of essentially pure nitrogen atmosphere such that the Si-particles of the sealing paste is nitrided and thus sealing the joints of the crucible and bonding the elements together. The second heat treatment is similar to the first, at about 1400° C. and a duration which nitrides all Si-particles in the sealing paste.

### Example 1

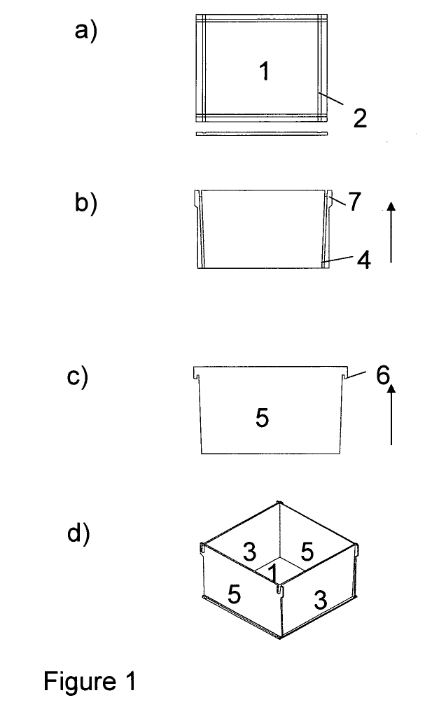

The crucible according to example 1 is schematically illustrated in FIG. 1a to 1d.

FIG. 1a illustrates the bottom plate 1, which is a quadratic plate with a groove 2 on the upward facing surface along each of its sides. The grove is fitted to the thickness of the side elements forming the walls of the crucible such that the lower edge of the side walls enters into the groove and forms a tight fitting. Alternatively, the side elements and the bottom groove may be given a complementary shape such as e.g. a plough and tongue.

FIG. 1b shows one rectangular wall element 3. There will be used two of these at opposing sides, see FIG. 1d. The side element 3 is equipped with a groove 4 along both edges on the surface facing inwards into the crucible. The grooves 4 are dimensioned to give a tight fitting with the side edges of the wall elements 5 placed perpendicularly on the wall elements 3. The grooves 4 and side edges of the wall elements 3 may be given an congruent angled orientation such that the wall element becomes shaped as an isosceles trapezium where the bottom and upper side edges are parallel and the side edges are forming congruent angles. This isosceles trapezium make the assembled crucible tapered such that the cross sectional area of the opening of the crucible is larger than the cross sectional area of the bottom of the crucible. The upper direction is indicated by the arrow in FIG. 1b. Also, at the upper part of the side edges, the wall element 3 may be equipped with a protrusion 7 which may form a locking grip with a corresponding protrusion on wall element 5, see FIG. 1d.

FIG. 1e shows the corresponding wall element 5 of the crucible according to the first example of the invention. There will be used two of these wall elements at opposing sides and perpendicularly between the wall elements 3, see FIG. 1d. The wall elements 5 is at the upper sides equipped with a protrusion 6, that is given a complementary shape as the protrusions 7 of the walls 3. The protrusions 6, 7 will form a looking grip when the protrusion 6 is thread into protrusion 7.

FIG. 1d illustrates the plate elements when assembled into a crucible. The sealing paste is applied in each groove 2, 4 before assembly. If the grooves 2, 4 and edges of the plate elements 3, 5 are given a sufficient dimensional accuracy, the crucible may be assembled with a sufficient tight fitting to obtain a leak proof crucible. In this case, the use of sealant paste and second heating may be omitted, the wall elements will be held in place by the protrusions 6, 7.

### Example 2

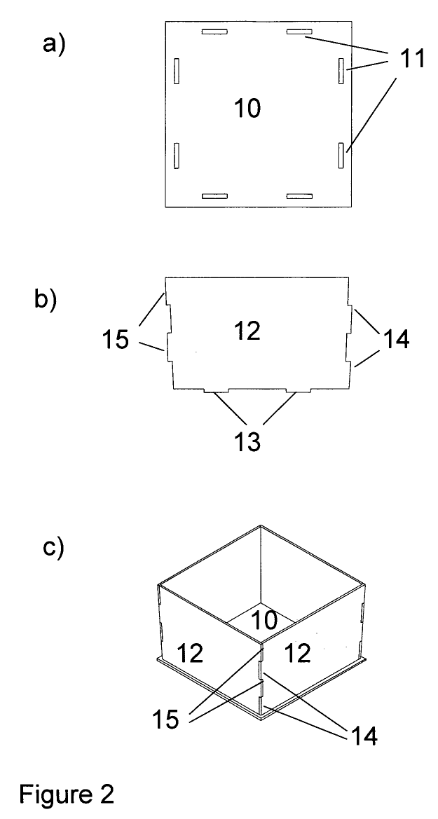

The crucible according to example 2 is schematically illustrated in FIG. 2a to 2c.

FIG. 2a illustrates the bottom plate 10, which is a quadratic plate with two elongated apertures 11 along each of its sides. The dimensions of the apertures are fitted such that they can receive a downward facing protrusion of the side walls and form a tight fitting. It is also envisioned to include grooves (not shown) running aligned with the centre axis of the apertures 11, similar to the grooves 2 of the bottom plate 1 of the first example.

FIG. 2b shows one wall element 12. There will be four of these elements, see FIG. 2c. The side element 12 is equipped with two protrusions 14, 15 on each side and two downward protrusions 13. The side protrusions are dimensioned such that the protrusion 14 enters the space between the protrusions 15 and forms a tight fitting when two wall elements 12 are assembled forming adjacent walls of the crucible. The downward facing protrusions 13 are dimensioned to fit into the apertures 11 and form a tight fitting, see FIG. 2c. The side edges of the wall elements 12 may be given a congruent angled orientation such that the wall element becomes shaped as an isosceles trapezium where the bottom and upper side edges are parallel and the side edges are forming congruent angles. This isosceles trapezium make the assembled crucible tapered such that the cross sectional area of the opening of the crucible is larger than the cross sectional area of the bottom of the crucible. The upper direction is indicated by the arrow in FIG. 2b.

FIG. 2c illustrates the plate elements 10, 12 when assembled into a crucible. The sealing paste is applied on each side edge and the lower edge of each wall element 12 before assembly.

### VERIFICATION OF THE INVENTION

The invention is verified by performing a set of calculations of the temperature profile across the crucible bottom and the underlying support of graphite carrying the crucible.

### Example 3

### Calculated Temperature Profile in a Furnace with Use of a Prior Art Silica Crucible

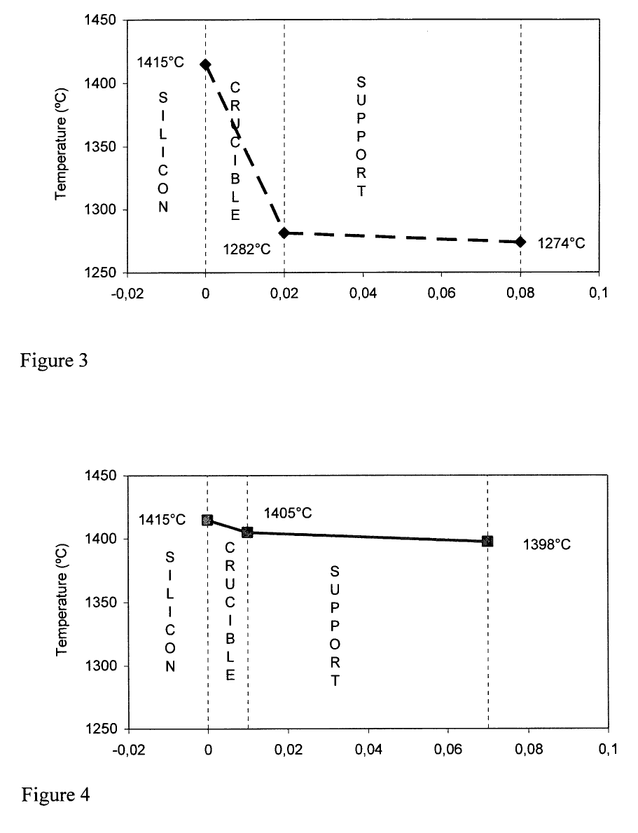

A calculation of a steady state one-dimensional temperature gradient at the start of crystallization with a standard furnace process is shown in FIG. 3. The temperature at the inside of the crucible bottom is 1415° C. The crucible bottom is 2 cm thick, and its thermal conductivity is 1.5 W/mK. The support plate is 60 mm thick, and its thermal conductivity is 80 W/mK. In order to remove 10 kW/m², the temperature at the bottom of the support plate must be lowered to 1398° C. This rate of heat transfer can give crystallization rates up to 0.9 cm/h, depending on the amount of heat transported from the top chamber.

### Example 4

### Calculated Temperature Profile in a Furnace with a Crucible According to the Invention

A calculation of a steady state one-dimensional temperature gradient with a silicon nitride crucible is shown in FIG. 4. The calculation illustrates the situation at the start of crystallization. The temperature at the inside of the crucible bottom is 1415° C. The crucible bottom is 1 cm thick, and its thermal conductivity is 10 W/m·K. The support plate is 60 mm thick, and its thermal conductivity is 80 W/m·K. In order to remove 10 kW/m², the temperature at the bottom of the support plate must be lowered to 1274° C. This rate of heat transfer can give crystallization rates up to 0.9 cm/h, depending on the amount of heat transported from the top chamber.

### Example 5

### Crystallising with a Patterned Carbon Plate Underneath the Crucible

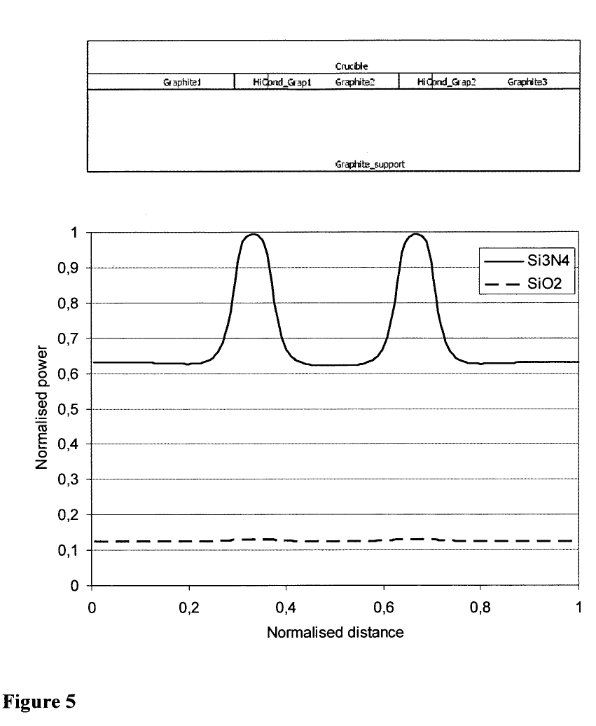

A two dimensional FEM model is used to calculate the effect of intentionally varying the heat flux in a pattern across the bottom of the ingot in order to promote crystal nucleation in certain areas and thereby obtaining larger crystals. The graphite support plate is 50 mm thick and has a thermal conductivity of 80 W/mK. Above there is a patterned plate, 10 mm thick with a base plate made of a low conductive graphite material, for instance CFC, with a thermal conductivity in the direction of heat flow of 10 W/mK. In this plate there is inserted pieces, 10 mm thick of highly conductive isotropic graphite with thermal conductivity of 80 W/mK. On this support structure there is placed a crucible according to the present invention with bottom thickness 10 mm and thermal conductivity 10 W/mK. With 1415° C. on the inside of the crucible bottom and 1200° C. under the graphite support plate, the heat flux is as shown in FIG. 5 (fully drawn curve). It is characterised by distinct local maxima at the position of the high conductive graphite pieces.

For comparison, a calculation is made with the same support structure and the same boundary conditions, but with a crucible commonly used in the art. It is made of SiO₂, has a bottom thickness of 20 mm and a thermal conductivity of 1.7 W/mK. The amount of heat extracted is much less, and the lateral variation is very small due to the large thermal resistance of the crucible.

1. A method for direct solidification of multi-crystalline semiconductor grade silicon ingots, said method comprising:
crystallizing the semiconductor grade silicon ingot, optionally also including the melting of the feed silicon material, in a crucible made of silicon nitride, or in a crucible made of a composite of silicon carbide and silicon nitride,
wherein the wall thickness of the bottom of the crucible is dimensioned such that the thermal resistance across the bottom is reduced to a level of at least the same order as thermal resistance across the support below carrying the crucible or lower.

2. The method according to claim 1, further comprising the step of thermally insulating the sidewalls of the crucible to obtain an essentially vertically oriented heat flux.

3. The method according to claim 2, further comprising the step of employing a layer of graphite or carbon felt as thermal insulation of the side walls of the crucible.

4. The method according to claim 1, wherein the method is applied for manufacturing solar grade multi-crystalline silicon ingots by directional solidification.

5. Method according to claim any of claim 4, wherein the directional solidification method is the Bridgman process or the block-casting process.

6. The method according to claim 1, further comprising the step of controlling the number of crystals formed at the beginning of the crystallisation by use of a composite sheet of graphite under the crucible with patterns of highly conducting oriented graphite and areas of isotropic graphite.

7. The method according to claim 1, further comprising the step of, after the initial crystallisation, reversing the heat flux resulting in a partial remelt of formed crystals before again reversing the heat flux to accomplish crystallisation.

8. A crucible for manufacturing ingots of semiconductor grade multi-crystalline silicon, comprising:
the crucible is made of silicon nitride, or of a composite of silicon carbide and silicon nitride,
wherein the wall thickness of the bottom of the crucible is dimensioned such that the thermal resistance across the bottom is reduced to a level of at least the same order as thermal resistance across the support below carrying the crucible or lower.

9. The crucible according to claim 8, wherein the crucible is assembled from one bottom plate element and four wall elements all made of nitride bonded silicon nitride (NBSN) defining a square cross sectional crucible, and the joints between adjacent wall elements and between the wall elements and bottom element are sealed and locked by applying a silicon containing sealant paste before assembly heated in a substantially pure nitrogen atmosphere to form a solid phase of silicon nitride.

10. The crucible according to claim 9, wherein:
the crucible is assembled using one bottom plate, two first wall elements, and two side walls second wall elements in an intermittent sequence,
the bottom plate is a quadratic plate with a groove along each side edge on the upward facing surface, and the groves are fitted such that a lower edge of the wall elements enters into the grooves and forms a tight fitting, and
the first wall elements are equipped with a groove along both edges on the surface facing inwards into the crucible, which are dimensioned to give a tight fitting with the side edges of the second wall elements.

11. The crucible according to claim 10, wherein: the grooves and side edges of the first wall elements are given a congruent angled orientation such that the wall element becomes shaped as an isosceles trapezium where the bottom and upper side edges are parallel and the side edges are forming congruent angles,
the first wall elements are equipped with a protrusions,
the second wall elements are equipped with a protrusions, and
the protrusions are shaped such that they form a locking grip holding wall elements tight together when assembling the crucible.

12. The crucible according to claim 9, wherein the wall elements and bottom element are assembled without use of sealing paste.

13. The crucible according to claim 8, wherein:
the crucible is assembled using one bottom plate and four side walls wall elements,
the bottom plate is a quadratic plate with two apertures along each side edge on the upward facing surface,
the wall elements are equipped with two downward facing protrusions fitted to enter the aperture and form a tight fitting with bottom elements, two side protrusions on one side edge and two protrusions on the other side edge, and
the protrusions are dimensioned such that the side protrusion enters the space between the protrusions and forms a tight fitting when two wall elements are assembled forming adjacent walls of the crucible.

14. The method according to claim 2, wherein the method is applied for manufacturing solar grade multi-crystalline silicon ingots by directional solidification.

15. The method according to claim 3, wherein the method is applied for manufacturing solar grade multi-crystalline silicon ingots by directional solidification.

16. The method according to claim 6, further comprising the step of, after the initial crystallisation, reversing the heat flux resulting in a partial remelt of formed crystals before again reversing the heat flux to accomplish crystallisation.

17. The crucible according to claim 10, wherein the wall elements and bottom element are assembled without use of sealing paste.

18. The crucible according to claim 11, wherein the wall elements and bottom element are assembled without use of sealing paste.
